(19) United States
(12) Patent Application Publication
(10) Pub. No.: US 2009/0061233 A1
(43) Pub. Date: Mar. 5, 2009

(54) Method of manufacturing flexible substrate for electronic device, method of manufacturing electronic device and electronic device manufactured thereby

(75) Inventor: Hiroyuki Yaegashi, Kanagawa (JP)

Correspondence Address: BIRCH STEWART KOLASCH & BIRCH, PO BOX 747, FALLS CHURCH, VA, 22040-0747, US

(73) Assignee: FUJIFILM CORPORATION

(21) Appl. No.: 11/898,891

(22) Filed: Sep. 17, 2007

(30) Foreign Application Priority Data
Aug. 27, 2007 (JP) 2007-220155

(51) Int. Cl. B32B 37/06; B32B 9/04

(52) U.S. Cl. 428/411.1; 156/308.2

(57) ABSTRACT

A method of manufacturing a flexible substrate for an electronic device having at least a barrier layer and a flattened layer above a flexible supporting member, in which the flattened layer is provided with at least a thermosetting resin layer. The method includes installing the barrier layer above the flexible supporting member, and installing the flattened layer by facing the thermosetting resin toward a face of the barrier layer and adhering the thermosetting resin and the barrier layer by heating. A method of manufacturing an electronic device and an electronic device manufactured thereby are also provided.

### CROSS-REFERENCE TO RELATED APPLICATION

This application, claims priority under 35 USC 119 from Japanese Patent Application No. 2007-220155, the disclosure of which is incorporated by reference herein.

### BACKGROUND OF THE INVENTION

1. Field of the Invention

The present invention relates to a method of manufacturing a flexible substrate for an electronic device, a method of manufacturing an electronic device and an electronic device manufactured thereby.

2. Description of Related Art

In recent years, various kinds of electronic devices, such as an electroluminescence element (organic electroluminescence element and inorganic electroluminescence element), a semiconductor element, a liquid crystal element, or electronic paper and the like have been widely utilized in a number of industrial fields.

Particularly, an electroluminescence element using a thin film material made to be luminescent by being excited by conducting a current achieves luminescence having high luminance by low voltage, and therefore, the electroluminescence element has wide latent uses in broad fields including portable telephone displays, personal digital assistants (PDA), computer displays, information displays of automobiles, TV monitors, and conventional illumination, and achieves advantages of thin formation, light-weight formation, small-size formation, and power saving in these fields. Therefore, there is great expectation that the electroluminescence element will play a leading role in the electronic display market in the future.

In these fields, further small-size formation, thin formation and light-weight formation are desired, and development of an electronic device using a flexible substrate, such as a thin film of a plastic film or the like, has been proceeding. For example, Japanese Patent Application Laid-Open (JP-A) No. 5-116254 discloses an electronic display using a flexible plastic film for a substrate in an organic electroluminescence element.

However, a flexible substrate has a number of technical problems to be resolved practically. One of the problems resides in that a barrier performance against a gas such as oxygen or the like or moisture is considerably lower than that of a glass substrate, and therefore, an electronic device is deteriorated. Although a number of attempts at installing a barrier layer have been carried out in JP-A No. 2004-174713, a sufficient effect has not been achieved. Various barrier layers provided at a glass substrate have been known, as described in, for example, JP-A No. 2004-119016, wherein the barrier layer is provided by vapor-depositing an inorganic material of silicon nitride, silicon oxinitride, aluminum nitride, aluminum oxinitride or the like. However, in the case where an inorganic vapor-deposited film is formed on a flexible substrate, there are problems in that a number of defects such as pin holes, cracks and the like occur.

Another technical problem resides in that a surface of a plastic film is not as flat as a surface of a glass substrate and includes countless irregular recesses and projections of an order of several micrometers through 10 and several micrometers, and therefore, it is difficult to uniformly provide functional layers of an electronic device provided with thickness of nanometer units.

### SUMMARY OF THE INVENTION

The present invention has been made in view of the above circumstances and provides a method of manufacturing a flexible substrate for an electronic device comprising at least a barrier layer and a flattened layer on a flexible supporting member, wherein the flattened layer comprises at least a thermosetting resin layer, the method comprising providing the barrier layer above the flexible supporting member, and providing the flattened layer by facing the thermosetting resin layer toward a face of the barrier layer and adhering the thermosetting resin layer and the barrier layer by heating.

Another aspect of the present invention is to provide a method of manufacturing a flexible electronic device comprising:

1) manufacturing a flexible substrate by providing a first barrier layer on a flexible supporting member, and providing a flattened layer by facing a thermosetting resin layer thereof toward a face of the first barrier layer and adhering the thermosetting resin layer and the first barrier layer by heating;

2) providing a second barrier layer on a surface of the flattened layer of the flexible substrate; and

3) providing functional layers of an electronic device on a surface of the second barrier layer.

A further aspect of the present invention is to provide a method of manufacturing a flexible electronic device comprising:

1) manufacturing a first flexible substrate including providing a first barrier layer above a first flexible supporting member, and providing a flattened layer by facing a first thermosetting resin layer toward a face of the first barrier layer and adhering the first thermosetting resin layer and the first barrier layer by heating;

2) providing a second barrier layer on a surface of the flattened layer of the first flexible substrate;

3) providing functional layers of an electronic device on a surface of the second barrier layer;

4) providing a third barrier layer to cover a surface of the functional layers; and

5) providing a protection film, which comprises a fourth barrier layer and a second thermosetting resin layer in order on a second flexible supporting member, by facing a face of the second thermosetting resin layer toward a face of the third barrier layer and adhering the second thermosetting resin layer and the third barrier layer by heating.

A still further aspect of the present invention is to provide an electronic device manufactured by the manufacturing methods described above.

### BRIEF DESCRIPTION OF THE DRAWINGS

FIG. 1 is a conceptual sectional view of a thermosetting resin layer film used for manufacturing a flexible substrate for an electronic device according to an embodiment of the invention.

FIG. 2 is a conceptual sectional view of a flexible substrate for an electronic device according to an embodiment of the invention.

FIG. 3 is a conceptual sectional view of a flexible organic EL element according to an embodiment of the invention.

### DETAILED DESCRIPTION OF THE INVENTION

The invention is intended to provide a method of manufacturing a flexible substrate for an electronic device that is improved in smoothness and excellent in preservation stability, a method of manufacturing an electronic device and an electronic device manufactured thereby.

### 1. Outline of the Invention

A first embodiment of the invention is a method of manufacturing a flexible substrate for an electronic device comprising at least a barrier layer and a flattened layer above a flexible supporting member, wherein the flattened layer includes at least a thermosetting resin layer, the method comprising providing the barrier layer on the flexible supporting member, and providing the flattened layer by facing the thermosetting resin layer toward a face of the barrier layer and adhering the thermosetting resin layer and the first barrier layer by heating.

A second embodiment of the invention is a method of manufacturing a flexible electronic device including:

1) manufacturing a flexible substrate by providing a first barrier layer on a flexible supporting member, and providing a flattened layer by facing the thermosetting resin layer thereof toward a face of the first barrier layer and adhering the thermosetting resin layer and the barrier layer by heating;

2) providing a second barrier layer on a surface of the flattened layer of the flexible substrate; and

3) providing functional layers of an electronic device on a surface of the second barrier layer.

Alternatively, the second embodiment is a method of manufacturing a flexible electronic device comprising:

1) manufacturing a first flexible substrate by providing a first barrier layer on a first flexible supporting member, and providing a flattened layer facing a first thermosetting resin layer a face of the first barrier layer and adhering the first thermosetting resin layer and the first barrier layer by heating;

2) providing a second barrier layer on a surface of the flattened layer of the first flexible substrate;

3) providing functional layers of an electronic device on a surface of the second barrier layer;

4) providing a third barrier layer to cover a surface of the functional layers; and

5) providing a protection film, which comprises a fourth barrier layer and a second thermosetting resin layer in order on a second flexible supporting member, by facing a face of the second thermosetting resin layer toward a face of the third barrier layer and adhering the second thermosetting resin layer and the third barrier layer by heating.

A third embodiment of the invention provides an electronic device manufactured by any of the methods of manufacturing an electronic device described above.

Although well known various electronic devices can be used as the electronic device according to the invention, luminescence devices such as an organic electroluminescence element, an inorganic electroluminescence element and the like, and a semiconductor element are preferable.

An explanation will be successively be given of a method of manufacturing a flexible substrate for an electronic device, a method of manufacturing an electronic device and an electronic device manufactured thereby as follows.

### 2. Flexible Substrate and Manufacturing Method Thereof

A flexible substrate according to the invention is a flexible substrate for an electronic device having at least a barrier layer and a flattened layer above a flexible supporting member.

A shape, a structure, a size and the like of the substrate is not particularly limited and can pertinently be selected in accordance with a use, an object or the like of a luminescent element. Generally, the shape is a film-like shape.

The structure may be a single layer structure or a laminated layer structure, and further, may be formed by a single member or may be formed by two or more members.

Although the substrate may be colorless transparent or colored transparent, it is preferable that the substrate is colorless transparent in view of not scattering or attenuating light emitted from the luminescent layer.

It is preferable for the substrate to provide a humidity permeation preventing layer (gas barrier layer) at a front surface or a back face (transparent electrode side) thereof. As a material of the humidity permeation preventing layer (gas barrier layer), an inorganic substance such as silicon nitride, silicon oxide or the like can preferably be used. The humidity permeation preventing layer (gas barrier layer) can be formed by, for example, a high frequency sputtering method or the like.

The substrate may be provided with a hard coat layer, an under coat layer and the like as necessary.

A method of manufacturing a flexible substrate according to the invention includes a step of providing at least a barrier layer on a flexible supporting member, and a step of providing a flattened layer by facing a thermosetting resin layer thereof toward a face of the barrier layer and adhering the thermosetting resin layer to the barrier layer by heating. Preferably, after facing the thermosetting resin layer toward the face of the barrier layer so as to overlap therewith, a flattened surface is formed by heating the thermosetting resin layer by a heat press.

1) Flexible Supporting Member

As a flexible supporting member used in the invention, a material which is not permeable to water or a material having an extremely low water permeation constant is preferable, and a material which does not scatter or attenuate light emitted from the organic compound layer is preferable. Specific examples include, for example, plastic materials of polyester such as polyethylene terephthalate, polybutylene terephthalate, polyethylene naphthalate or the like, polystyrene, polycarbonate, polyether sulfone, polyarylate, aryl diglycol carbonate, polyimide, polycycloolefin, norbornene resin, and poly (chlorotrifluoro ethylene) and the like.

It is preferable that the film thickness is 10 μm to 1 mm. More preferably, the film thickness is 50 μm to 700 μm. When the thickness is excessively large, flexibility is lost, which is not preferable, and when the thickness is excessively thin, handling thereof becomes difficult, which is not preferable.

It is preferable that the flexible supporting member used in the invention is excellent in heat resistance, dimensional stability, solvent resistance, electric insulating property, workability, low air permeability, low hygroscopic property and the like.

2) Barrier Layer

A barrier layer used in the invention is a barrier layer provided above the flexible supporting member and is a layer for preventing an electronic device from being deteriorated by invasion of moisture or a gas such as oxygen or the like.

As a material for the barrier layer used in the invention, silicone nitride, silicon oxinitride, silicone oxide, and silicon carbide are preferably used.

The barrier layer used in the invention can be formed by a CVD method, an ion plating method, a sputtering method, or by a vapor deposition method.

It is preferable that a thickness of the barrier layer used in the invention is 0.01 μm through 10 μm. When the thickness is thinner than 0.01 μm an insulating function and a function of preventing invasion of moisture or a gas becomes insufficient, and therefore, it is not preferable.

Further, when the thickness is thicker than 10 μm, it takes time to form a film, which is not preferable in view of producibility. Further, there are cases where this increases a film stress, whereby film exfoliation or the like is brought about, which is not preferable. A thicker film can be provided by repeating film forming a plurality of times.

3) Method of Manufacturing Flexible Substrate

A thermosetting resin in a sheet-like shape is manufactured by coating and drying a thermosetting barrier layer composition mixed in a solvent on a temporary support such as a transparent polyethylene terephthalate film or the like.

Successively, the thermosetting resin in the sheet-like shape peeled off from the transparent polyethylene terephthalate film and a flexible supporting member having a barrier layer are superposed with each others to form an assembly, and the flexible substrate can be manufactured by heating the assembly or heating by a heat press the assembly.

It is preferable that a thickness of the thermosetting resin in the sheet-like shape used in the invention is 1 μm to 50 μm, and more preferably, 5 μm to 30 μm. When the thermosetting resin is excessively thick, flexibility is lost, which is not preferable, and when it is excessively thin, handling thereof becomes difficult, which is not preferable.

### 3. Electronic Device and Manufacturing Method Thereof

Although various well known electronic devices can be used as the electronic device of the invention, luminescence devices such as an organic electroluminescence element or an inorganic electroluminescence element, and a semiconductor element are preferable.

### 3-1. Organic Electroluminescence Device

An organic electroluminescence device in the present invention may have, in addition to the light-emitting layer, conventionally known organic compound layers such as a positive hole-transport layer, an electron-transport layer, a blocking layer, an electron-injection layer and a positive hole-injection layer.

In the following, the organic electroluminescence device of the present invention will be described in detail.

1) Layer Configuration

<Electrode>

At least one of a pair of electrodes of the organic electroluminescence device of the present invention is a transparent electrode, and the other one is a rear surface electrode. The rear surface electrode may be transparent or non-transparent.

<Configuration of Organic Compound Layer>

A layer configuration of the at least one organic compound layer can be appropriately selected, without particular restriction, depending on an application of the organic electroluminescence device and an object thereof. However, the organic compound layers are preferably formed on the transparent electrode or the rear surface electrode. In these cases, the organic compound layers are formed on front surfaces or one surface on the transparent electrode or the rear surface electrode.

A shape, size and thickness of the organic compound layers can be appropriately selected, without particular restriction, depending on applications thereof.

Examples of specific layer configurations include those cited below, but the present invention is not restricted to those configurations.

Anode/positive hole-transport layer/light-emitting layer/electron-transport layer/cathode,

Anode/positive hole-transport layer/light-emitting layer/blocking layer/electron-transport layer/cathode,

Anode/positive hole-transport layer/light-emitting layer/blocking layer/electron-transport layer/electron-injection layer/cathode,

Anode/positive hole-injection layer/positive hole-transport layer/light-emitting layer/blocking layer/electron-transport layer/cathode, and

Anode/positive hole-injection layer/positive hole-transport layer/light-emitting layer/blocking layer/electron-transport layer/electron-injection layer/cathode.

In the following, the respective layers will be described in detail.

2) Positive Hole-Transport Layer

The positive hole-transport layer that is used in the present invention includes a positive hole transporting material. For the positive hole transporting material, any material can be used without particular restriction as far as it has either one of a function of transporting holes or a function of blocking electrons injected from the cathode. As the positive hole transporting material that can be used in the present invention, either one of a low molecular weight hole transporting material and a polymer hole transporting material can be used.

Specific examples of the positive hole transporting material that can be used in the present invention include a carbazole derivative, a triazole derivative, an oxazole derivative, an oxadiazole derivative, an imidazole derivative, a polyarylalkane derivative, a pyrazoline derivative, a pyrazolone derivative, a phenylenediamine derivative, an arylamine derivative, an amino-substituted chalcone derivative, a styrylanthracene derivative, a fluorenone derivative, a hydrazone derivative, a stilbene derivative, a silazane derivative, an aromatic tertiary amine compound, a styrylamine compound, an aromatic dimethylidene-based compound, a porphyrin-based compound, a polysilane-based compound, a poly(N-vinylcarbazole) derivative, an aniline-based copolymer, electric conductive polymers or oligomers such as a thiophene oligomer and polythiophene, and polymer compounds such as a polythiophene derivative, a polyphenylene derivative, a polyphenylenevinylene derivative and a polyfluorene derivative.

These compounds may be used singularly or in a combination of two or more.

A thickness of the positive hole-transport layer is preferably 10 nm to 200 nm, and more preferably 20 nm to 80 nm. When the thickness exceeds 200 nm, the driving voltage increases in some cases, and when it is less than 10 nm, the light-emitting element may be short-circuited, which are not preferable.

3) Positive Hole-Injection Layer

In the present invention, a positive hole-injection layer may be disposed between the positive hole-transport layer and the anode.

The positive hole-injection layer is a layer that makes it easy for holes to be injected from the anode to the positive hole-transport layer, and specifically, a material having a small ionization potential among the positive hole transporting materials cited above is preferably used. For instance, a phthalocyanine compound, a porphyrin compound and a star-burst type triarylamine compound can be preferably used.

A film thickness of the positive hole-injection layer is preferably 1 nm to 30 nm.

4) Light-Emitting Layer

A light-emitting layer in the present invention comprises at least one light emitting material, and may comprise as necessary other compounds such as a positive hole transporting material, an electron transporting material, and a host material.

Any of light emitting materials can be used without particular restriction. Either of fluorescent emission materials or phosphorescent emission materials can be used, but the phosphorescent emission materials are preferred in view of the luminescent efficiency.

Examples of the above-described fluorescent emission materials include, for example, a benzoxazole derivative, a benzimidazole derivative, a benzothiazole derivative, a styrylbenzene derivative, a polyphenyl derivative, a diphenylbutadiene derivative, a tetraphenylbutadiene derivative, a naphthalimide derivative, a coumarin derivative, a perylene derivative, a perinone derivative, an oxadiazole derivative, an aldazine derivative, a pyralidine derivative, a cyclopentadiene derivative, a bis-styrylanthracene derivative, a quinacridone derivative, a pyrrolopyridine derivative, a thiadiazolopyridine derivative, a styrylamine derivative, aromatic dimethylidene compounds, a variety of metal complexes represented by metal complexes or rare-earth complexes of 8-quinolynol, polymer compounds such as polythiophene, polyphenylene and polyphenylenevinylene, organic silanes, and the like. These compounds may be used singularly or in a combination of two or more.

The phosphorescent emission material is not particularly limited, but an ortho-metal complex or a porphyrin metal complex is preferred.

The ortho-metal complex referred to herein is a generic designation of a group of compounds described in, for instance, Akio Yamamoto, Yuki Kinzoku Kagaku, Kiso to Oyo (“Organic Metal Chemistry Fundamentals and Applications”) (Shokabo, 1982), pp. 150-232, and H. Yersin, Photochemistry and Photophysics of Coordination Compounds (New York: Springer-Verlag, 1987), pp. 71-77 and pp. 135-146. The ortho-metal complex can be advantageously used as a light emitting material because high brightness and excellent emitting efficiency can be obtained.

As a ligand that forms the ortho-metal complex, various kinds can be cited and are described in the above-mentioned literature as well. Examples of preferable ligands include a 2-phenylpyridine derivative, a 7,8-benzoquinoline derivative, a 2-(2-thienyl)pyridine derivative, a 2-(1-naphtyl)pyridine derivative and a 2-phenylquinoline derivative. The derivatives may be substituted by a substituent as needs arise. Furthermore, the ortho-metal complex may have other ligands than the ligands mentioned above.

An ortho-metal complex used in the present invention can be synthesized according to various kinds of known processes such as those described in Inorg. Chem., 1991, Vol. 30, pp. 1685; Inorg. Chem., 1988, Vol. 27, pp. 3464; Inorg. Chem., 1994, Vol. 33, pp. 545; Inorg. Chim. Acta, 1991, Vol. 181, pp. 245; J. Organomet. Chem., 1987, Vol. 335, pp. 293 and J. Am. Chem. Soc., 1985, Vol. 107, pp. 1431.

Among the ortho-metal complexes, compounds emitting from a triplet exciton can be preferably employed in the present invention from the viewpoint of improving emission efficiency.

Furthermore, among the porphyrin metal complexes, a porphyrin platinum complex is preferable.

The phosphorescent light emitting materials may be used singularly or in a combination of two or more. Furthermore, a fluorescent emission material and a phosphorescent emission material may be simultaneously used.

A host material is a material that has a function of causing an energy transfer from an excited state thereof to the fluorescent emission material or the phosphorescent emission material to cause light emission from the fluorescent emission material or the phosphorescent emission material.

As the host material, as long as a compound can transfer exciton energy to a light emitting material, any compound can be appropriately selected and used depending on an application without particular restriction. Specific examples thereof include: a carbazole derivative; a triazole derivative; an oxazole derivative; an oxadiazole derivative; an imidazole derivative; a polyarylalkane derivative; a pyrazoline derivative; a pyrazolone derivative; a phenylenediamine derivative; an arylamine derivative; an amino-substituted chalcone derivative; a styrylanthracene derivative; a fluorenone derivative; a hydrazone derivative; a stilbene derivative; a silazane derivative; an aromatic tertiary amine compound; a styrylamine compound; an aromatic dimethylidene-based compound; a porphyrin-based compound; an anthraquinonedimethane derivative; an anthrone derivative; a diphenylquinone derivative; a thiopyran dioxide derivative; a carbodiimide derivative; a fluorenylidenemethane derivative; a distyrylpyrazine derivative; heterocyclic tetracarboxylic anhydrides such as naphthalene perylene; a phthalocyanine derivative; various kinds of metal complexes typified by metal complexes of a 8-quinolinol derivative, metal phthalocyanine, and metal complexes with benzoxazole or benzothiazole as a ligand; polysilane compounds; a poly(N-vinylcarbazole) derivative; an aniline-based copolymer; electric conductive polymers or oligomers such as a thiophene oligomer and polythiophene; polymer compounds such as a polythiophene derivative, a polyphenylene derivative, a polyphenylenevinylene derivative and a polyfluorene derivative; and like. These compounds can be used singularly or in a combination of two or more.

A content of the host material in the light-emitting layer is preferably in the range of 0 to 99.9% by weight and more preferably in the range of 0 to 99.0% by weight.

5) Blocking Layer

In the present invention, a blocking layer may be disposed between the light-emitting layer and the electron-transport layer. The blocking layer is a layer that inhibits excitons generated in the light-emitting layer from diffusing and holes from penetrating to a cathode side.

A material that is used in the blocking layer may be a general electron transporting material, as long as it can receive electrons from the electron-transport layer and deliver them to the light-emitting layer, without being particularly restricted. Examples thereof include a triazole derivative; an oxazole derivative; an oxadiazole derivative; a fluorenone derivative; an anthraquinodimethane derivative; an anthrone derivative; a diphenylquinone derivative; a thiopyran dioxide derivative; a carbodiimide derivative; a fluorenylidenemethane derivative; a distyrylpyrazine derivative; heterocyclic tetracarboxylic anhydrides such as naphthalene perylene; a phthalocyanine derivative; various kinds of metal complexes typified by metal complexes of a 8-quinolinol derivative, metal phthalocyanine, and metal complexes with benzoxazole or benzothiazole as a ligand; electric conductive polymer oligomers such as an aniline-based copolymer, a thiophene oligomer and polythiophene; and polymer compounds such as a polythiophene derivative, a polyphenylene derivative, a polyphenylenevinylene derivative and a polyfluorene derivative. These can be used singularly or in a combination of two or more.

6) Electron-Transport Layer

In the present invention, an electron-transport layer including an electron transporting material can be disposed.

The electron transporting material can be used without particular restriction, as long as it has either one of a function of transporting electrons or a function of blocking holes injected from the anode. The electron transporting materials that were cited in the explanation of the blocking layer can be preferably used.

A thickness of the electron-transport layer is preferably 10 nm to 200 nm and more preferably 20 nm to 80 nm.

When the thickness exceeds 200 nm, the driving voltage increases in some cases, and when it is less than 10 nm, the light-emitting element may be short-circuited, which are not preferable.

7) Electron-Injection Layer

In the present invention, an electron-injection layer can be disposed between the electron-transport layer and the cathode.

The electron-injection layer is a layer by which electrons can be readily injected from the cathode to the electron-transport layer. Specifically, lithium salts such as lithium fluoride, lithium chloride and lithium bromide; alkali metal salts such as sodium fluoride, sodium chloride and cesium fluoride; and electric insulating metal oxides such as lithium oxide, aluminum oxide, indium oxide and magnesium oxide can be preferably used.

A film thickness of the electron-injection layer is preferably 0.1 nm to 5 nm.

8) Producing Method of Organic Compound Layer

The respective layers that constitute an element in the present invention can be preferably formed by any method of dry layering methods such as a vapor deposition method and a sputtering method, and wet layering methods such as a dipping method, a spin coating method, a dip coating method, a casting method, a die coating method, a roll coating method, a bar coating method and a gravure coating method.

Among these, from the viewpoints of emission efficiency and durability, the dry methods are preferable.

Next, a substrate and electrodes for the present invention are explained.

9) Substrate

The substrate to be applied in the present invention is preferably impermeable to moisture or very slightly permeable to moisture. Furthermore, the substrate preferably does not scatter or attenuate light emitted from the organic compound layer. Specific examples of materials for the substrate include YSZ (zirconia-stabilized yttrium); inorganic materials such as glass; polyesters such as polyethylene terephthalate, polybutylene phthalate and polyethylene naphthalate; and organic materials such as polystyrene, polycarbonate, polyethersulfon, polyarylate, aryldiglycolcarbonate, polyimide, polycycloolefin, norbornene resin, poly(chlorotrifluoroethylene), and the like.

The substrate used in the present invention is preferably a plastic substrate, and a film selected from the plastic materials described above can be preferably used.

In the case of employing an organic material, it is preferred to use a material excellent in heat resistance, dimensional stability, solvent-resistance, electrical insulation, workability, low air-permeability, and low moisture-absorption. Among these, in the case that a material for an electrode is Indium Tin Oxide (ITO) which is preferably used as a material for a transparent electrode, a material having a small difference in lattice constant from that of Indium Tin Oxide (ITO) is preferable. These can be used singularly or in a combination of two or more.

There is no particular limitation as to the shape, the structure, the size and the like of the substrate, but it may be suitably selected according to the application, the purposes and the like of the luminescent device. In general, a plate-like substrate is preferred as the shape of the substrate. The structure of the substrate may be a monolayer structure or a laminated structure. Furthermore, the substrate may be formed from a single member or from two or more members.

Although the substrate may be in a transparent and colorless, or a transparent and colored condition, it is preferred that the substrate is transparent and colorless from the viewpoint that the substrate does not scatter or attenuate light emitted from the light-emitting layer.

A moisture permeation preventive layer (gas barrier layer) may be provided on the front surface or the back surface (transparent electrode side) of the substrate.

For a material of the moisture permeation preventive layer (gas barrier layer), inorganic substances such as silicon nitride and silicon oxide may be preferably applied. The moisture permeation preventive layer (gas barrier layer) may be formed in accordance with, for example, a high-frequency sputtering method or the like.

A hard-coat layer or an under-coat layer may be further provided on the substrate as necessary.

10) Anode

An anode in the present invention may generally have a function as an electrode for supplying positive holes to the organic compound layer, and while there is no particular limitation as to the shape, the structure, the size and the like, it may be suitably selected from among well-known electrode materials according to the application and the purpose thereof.

As materials for the anode, for example, metals, alloys, metal oxides, electric conductive compounds, and mixtures thereof are preferably used, wherein those having a work function of 4.0 eV or more are preferred. Specific examples of the anode materials include electric conductive metal oxides such as tin oxides doped with antimony, fluorine or the like (ATO and FTO), tin oxide, zinc oxide, indium oxide, indium tin oxide (ITO), and indium zinc oxide (IZO); metals such as gold, silver, chromium, and nickel; mixtures or laminates of these metals and the electric conductive metal oxides; inorganic electric conductive materials such as copper iodide, and copper sulfide; organic electric conductive materials such as polyaniline, polythiophene, and polypyrrole; and laminates of these inorganic or organic electron-conductive materials with ITO.

The anode may be formed on the substrate, for example, in accordance with a method which is appropriately selected from among wet methods such as a printing method, a coating method and the like; physical methods such as a vacuum deposition method, a sputtering method, an ion plating method and the like; and chemical methods such as CVD and plasma CVD methods and the like with consideration of the suitability with a material constituting the anode. For instance, when ITO is selected as a material for the anode, the anode may be formed in accordance with a DC or high-frequency sputtering method, a vacuum deposition method, an ion plating method or the like.

In the organic electroluminescence device of the present invention, a position at which the anode is to be formed is not particularly restricted, but it may be suitably selected according to the application and the purpose of the luminescent device. The anode may be formed on either the whole surface or a part of the surface on either side of the substrate.

For patterning to form the anode, a chemical etching method such as photolithography, a physical etching method such as etching by laser, a method of vacuum deposition or sputtering through superposing masks, and a lift-off method or a printing method may be applied.

A thickness of the anode may be suitably selected dependent on the material constituting the anode, and is not definitely decided, but it is usually in the range of around 10 nm to 50 μm, and 50 nm to 20 μm is preferred.

A value of electric resistance of the anode is preferably 10³ Ω/□ or less, and 10² Ω/□ or less is more preferable.

The anode in the present invention can be colorless and transparent or colored and transparent. For extracting luminescence from the transparent anode side, it is preferred that a light transmittance of the anode is 60% or higher, and more preferably 70% or higher. The light transmittance in the present invention can be measured by a method well known in the art using a spectrophotometer.

Concerning the transparent anode, there is a detailed description in “TOUMEI DENNKYOKU-MAKU NO SHINTENKAI (Novel Developments in Transparent Electrode Films)” edited by Yutaka Sawada and published by C.M.C. in 1999, the contents of which are incorporated by reference herein. In the case where a plastic substrate of a low heat resistance is applied, it is preferred that ITO or IZO is used to obtain a transparent anode prepared by forming the film at a low temperature of 150° C. or lower.

11) Cathode

The cathode in the present invention may generally have a function as an electrode for injecting electrons to the organic compound layer, and there is no particular restriction as to the shape, the structure, the size and the like. Accordingly, the cathode may be suitably selected from among well-known electrode materials.

As the materials constituting the cathode, for example, metals, alloys, metal oxides, electric conductive compounds, and mixtures thereof may be used, wherein materials having a work function of 4.5 eV or less are preferred. Specific examples thereof include alkali metals (e.g., Li, Na, K, Cs or the like); alkaline earth metals (e.g., Mg, Ca or the like); gold; silver; lead; aluminum; sodium-potassium alloys; lithium-aluminum alloys; magnesium-silver alloys; rare earth metals such as indium and ytterbium; and the like. They may be used alone, but it is preferred that two or more of them are used in combination from the viewpoint of satisfying both of stability and electron injectability.

Among these, as the materials for constituting the cathode, alkaline metals or alkaline earth metals are preferred in view of electron injectability, and materials containing aluminum as the major component are preferred in view of excellent preservation stability.

The term “material containing aluminum as the major component” refers to a material that exists in the form of aluminum alone; alloys comprising aluminum and 0.01% by weight to 10% by weight of an alkaline metal or an alkaline earth metal; or mixtures thereof (e.g., lithium-aluminum alloys, magnesium-aluminum alloys and the like).

As for materials for the cathode, they are described in detail in JP-A Nos. 2-15595 and 5-121172, the contents of which are incorporated by reference herein.

A method for forming the cathode is not particularly limited, but it may be formed in accordance with a well-known method. For instance, the cathode may be formed in accordance with a method which is appropriately selected from among wet methods such as a printing method, a coating method and the like; physical methods such as a vacuum deposition method, a sputtering method, an ion plating method and the like; and chemical methods such as CVD and plasma CVD methods and the like, while taking the suitability to a material constituting the cathode into consideration. For example, when a metal (or metals) is (are) selected as a material (or materials) for the cathode, one or two or more of them may be applied at the same time or sequentially in accordance with a sputtering method or the like.

For patterning to form the cathode, a chemical etching method such as photolithography, a physical etching method such as etching by laser, a method of vacuum deposition or sputtering through superposing masks, and a lift-off method or a printing method may be applied.

In the present invention, a position at which the cathode is to be formed is not particularly restricted, but it may be formed on either the whole or a part of the organic compound layer.

Furthermore, a dielectric material layer made of a fluoride or the like of an alkaline metal or an alkaline earth metal may be inserted in between the cathode and the organic compound layer with a thickness of 0.1 nm to 5 nm. The dielectric material layer may be formed in accordance with, for example, a vacuum deposition method, a sputtering method, an on-plating method or the like.

A thickness of the cathode may be suitably selected dependent on materials for constituting the cathode and is not definitely decided, but it is usually in the range of around 10 nm to 5 μm, and 50 nm to 1 μm is preferred.

Moreover, the cathode may be transparent or opaque. The transparent cathode may be formed by preparing a material for the cathode with a small thickness of 1 nm to 10 nm, and further laminating a transparent electric conductive material such as ITO or IZO thereon.

### 3-2. Inorganic Electroluminescence Element

An inorganic electroluminescence element includes a first and a second insulating layer comprising an oxide having a high dielectric constant arranged between electrodes, and functional layers of a luminescence layer or the like comprising sulfide interposed between the insulating layers. As an insulating layer, a material such as tantalum pentaoxide (Ta₂O₅), titanium oxide (TiO₂), yttrium oxide (Y₂O₃), barium titanate (BaTiO₃), strontium titanate (SrTiO₃) or the like can be used. A luminescence layer using a material such as zinc sulfide (ZnS), calcium sulfide (CaS), strontium sulfide (SrS), barium thioaluminate (BaAl₂S₄) or the like can be used as a base material of the luminescence layer, and a small amount of a transition metal element such as manganese (Mn) or the like, or a rare earth element such as europium (Eu), cerium (Ce), terbium (Th) or the like can be included as a luminescence center.

### 3-3. Semiconductor Element

A semiconductor element is a photoelectric conversion element including functional layers of a semiconductor layer subjected to pn junction or pin junction between electrodes, an X-ray photoconductor layer for generating electric charge by irradiation of X-rays or the like, and capable of being utilized in a photo-detector, a solar cell, an X-ray detector or the like. Although materials are pertinently selected for respective uses, amorphous silicon (a-Si), poly-crystal silicon, amorphous selenium (a-Se), cadmium sulfide (CdS), cadmium telluride (CdTe), zinc oxide (ZnO), lead oxide (PbO), lead iodide (PbI₂), Bi₁₂(Ge, Si)O₂₀ or the like can be used. These can be doped with an impurity as necessary to control a conduction type.

### 3-4. Piezoelectric Conversion Element

A piezoelectric conversion element includes functional layers of a layer which generates strain by a voltage between electrodes or generates a voltage by pressure or strain, or the like. The piezoelectric conversion element can be used for a pressure sensor, an acceleration sensor, an ultrasonic oscillator, an actuator or the like. As a material of a piezoelectric layer, lead titanate zirconate (PZT), lead titanate (PbTiO₃), lithium niobate (LiNbO₃), lithium tantalate (LiTaO₃), tetra lithium borate (Li₂B₄O₇), aluminum nitride (AlN), quartz (SiO₂), polyvinylidene fluoride (PVDF) or the like can be used.

A gas detecting layer includes an n-type semiconductor layer having an electric resistance that changes in presence of gas between electrodes or the like. As a material of an n-type semiconductor layer, tin oxide (SnO₂), zinc oxide (ZnO) or the like can be used. A complex substance in which nano particles of metal of Ag or the like are carried in holes of porous silicon oxide (SiO₂) can also be used.

### 4. Second to Fourth Barrier Layers

As each of a second to a fourth barrier layer in the invention, a layer having a composition similar to that of the first barrier layer can be used.

As the second to the fourth barrier layers in the invention, an organic barrier layer can also be used. An organic barrier layer in the invention is laminated above an inorganic barrier layer and can make a barrier property further complete by compensating for defects such as pin holes or the like of the inorganic barrier layer. Furthermore, the organic barrier layer has a function of preventing cracks from occurring at an element by alleviating stress when a flexible electronic device is bent.

### <Material>

The organic barrier layer according to the invention includes a fluororesin. As the fluororesin in the invention, a copolymer including a fluoroethylene polymer and copolymer thereof with another comonomer, or a fluorine-containing copolymer having a cyclic structure at a copolymer main chain is preferable, and, for example, polytetra fluoroethylene, polychlorotrifluoroethylene, polydichlorodifluoroethylene, chlorotrifluoroethylene, dichlorodifluoroethylene, and a copolymer including these are preferable. Polychlorotrifluoroethylene (PCTFE) is particularly preferable, and a commercially available flexible sheet can be used as it is. For example, a NITOFLON sheet made by Nitto Denko (Corporation) can be used.

Although a thickness of the organic barrier layer is not particularly limited, the thickness is preferably 10 μm to 1 mm. When the thickness is thinner than the range, a function of preventing invasion of moisture is deteriorated, which is not preferable. Further, when the thickness is thicker than the range, a thickness of the electroluminescence element itself increases to deteriorate thin film performance which is a characteristic of the organic electroluminescence element.

### <Thermally Melting Adhering Agent>

The organic barrier layer according to the invention is preferably thermally brought into press contact with the inorganic seal layer by a thermally melting adhering agent (hot melt type adhering agent) so as to be arranged thereon.

As the thermally melting adhering agent, those suitable in terms of temperature property or the like can be selected from generally known hot melt adhering agents and used, and those containing, as the main ingredient, copolymer of ethylene-acrylic acid or copolymer of ethylene-methacrylic acid having an ethylene content of 85 mole % to 99 mole % (particularly preferably, 88 mole % to 97 mole %) can preferably be used. Naturally, a mixture of the two copolymers may be used. When the ethylene content of the copolymers is smaller than 85 mole %, there is a tendency for reduction in humidity resistance, and further, when larger than 99 mole %, a force of adhering to a PCTFE layer becomes deficient and a practical compound film becomes difficult to provide, and therefore, both of these are not preferable. Furthermore, when the ethylene content of the two copolymers falls in the range, the larger the ethylene content is (the smaller the content of acrylic acid or methacrylic acid is), the more excellent the humidity resistance of the hot melt adhering agent becomes.

Although the hot melt adhering agent according to the invention may be constituted only by the copolymers, the copolymers may be blended with pertinent amounts of additives such as an oxidation preventive agent, a filling agent, a viscosity providing agent, an ultraviolet ray absorbing agent and the like. Further, when the copolymers are cross-linked, an organic peroxide of diacyl peroxide, peroxyketal, hydroperoxide, dialkyl peroxide, peroxidester or the like can also be blended. Due to the cross-linking, the hot melt adhering agent has resistance to softening or aggregation destruction, even when exposed to high temperatures, and therefore, humidity resistance under a high temperature environment is further improved.

Although a copolymer constituting ethylene as one component such as, for example, a copolymer of ethylene-vinyl acetate or copolymer of ethylene-ethylacrylate has already been used as a hot melt adhering agent as described above, the copolymer used in the invention is one in which ethylene and a monomer different from vinyl acetate or ethylacrylate are copolymerized, and differs from the hot melt adhering agents generally known in the art. Furthermore, although JP-A No. 2-297893 describes that copolymer of ethylene-acrylic acid is used as a hot melt adhering agent as described above, the publication does not refer to a composition ratio of monomers constituting the copolymers. In the invention, the humidity resistance of ethylene-acrylic acid copolymer has been studied, and a desired object can be achieved by making a composition ratio of the two fall in the specific range, and this differs from the hot melt adhering agents generally known in the art in this respect as well.

### <Laminate of PCTFE Film and Thermally Melting Adhering Agent>

The organic barrier layer according to the invention can be provided by a method of laminating together a PCTFE film and a film-like hot melt adhering agent and bonding to integrate the two by heating and pressurizing, or a method of melting to extrude hot melt adhering agents to one face of the PCTFE film or the like. Further, in order to promote a strength of bonding the PCTFE layer and the hot melt adhering agent layer, a surface of the PCTFE layer can also be subjected to an anchoring treatment such as a sputter etching treatment (disclosed in, for example, JP-B No. 53-22108, JP-B No. 56-1337 or the like), or a primer coating treatment.

Furthermore, it is also preferable to add a filler to at least one material of the PCTFE film and the thermally melting adhering agent.

As a filler added to the sealing agent, an inorganic material such as SiO (silicon oxide), SiON (silicon oxinitride), SiN (silicon nitride) or the like, or a metal material such as Ag, Ni (nickel), Al (aluminum) or the like is preferable. By adding the filler, a viscosity of the sealing agent is increased, workability is promoted, and humidity resistance is promoted.

The invention will be explained with reference to the drawings.

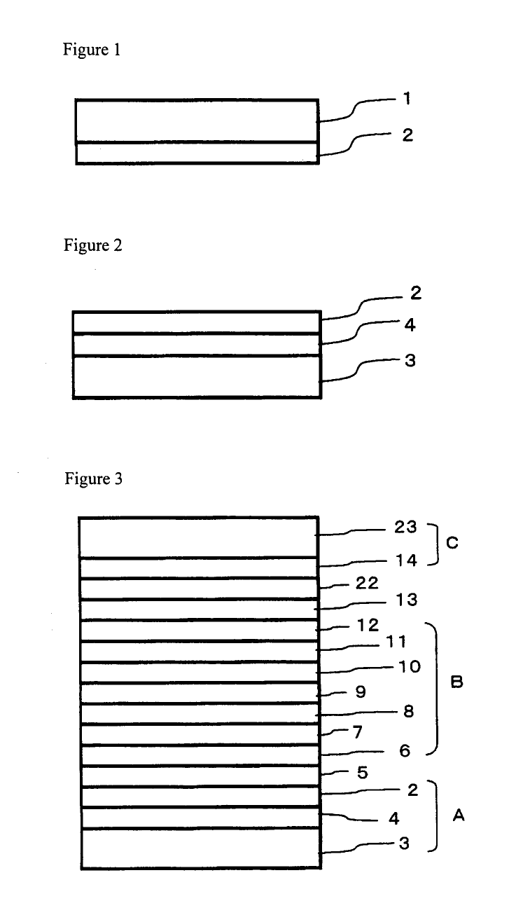

FIG. 1 is an outline sectional view of a thermosetting resin film used for manufacturing a flexible substrate for an electronic device according to an embodiment of the invention. As explained in Example 1 in the present application, a thermosetting resin layer 2 is formed by hot melting a thermoplastic resin or coating a solution in which the thermosetting resin is dissolved in a solvent capable of dissolving the thermosetting resin onto a temporary support 1, and carrying out drying. As the temporary support, a plastic film of a polyester film such as polyethylene terephthalate, polyethylene naphthalate or the like, or a polyalkylene film of polyethylene, polypropylene or the like can be used. A surface of the plastic film normally has a weak force of bonding with a thermoplastic resin so far as the surface is not made to be reactive by a surface ionizing treatment such as a glow discharge treatment or the like or a chemical surface treatment technique and therefore, the coated thermosetting resin layer can easily be peeled off from the temporary support.

FIG. 2 is an outline sectional view of a flexible substrate for an electronic device according to an embodiment of the invention. As explained in Example 1 in the specification, a barrier layer 4 is provided on a flexible supporting member 3. As the barrier layer 4, normally, an inorganic barrier layer is provided for enhancing a barrier performance against oxygen or moisture. A thermosetting resin layer also functions as an organic barrier layer, and therefore, a complex barrier layer of an organic barrier layer and an inorganic barrier layer is formed to further intensify the barrier property. Next, by peeling off the thermosetting resin layer 2 from the thermoplastic resin film explained with reference to FIG. 1, laminating the thermosetting resin layer 2 on the barrier layer 4, and heating by a heat press or the like from thereabove, the thermosetting resin layer 2 is adhered with the barrier layer 4, and the surface of the thermosetting resin layer is made smooth. Although normally the flexible supporting member 3 has irregular recesses and projections of a micrometer order at a surface thereof, a surface of the flexible substrate provided by the heat press becomes a flat and smooth surface due to the recesses and projections also being absorbed.

FIG. 3 is an outline sectional view of a flexible organic EL element according to an embodiment of the invention. As explained in Example 2 in the specification, a second barrier layer 5 and organic EL functional layer group B are successively provided above the resin layer 2 of the flexible substrate A. The organic EL function layer group B includes a transparent anode 6, a hole injecting layer 7, a hole transporting layer 8, a luminescent layer 9, an electron transporting layer 10, an electron injecting layer 11, and a cathode 12. Next, a third barrier layer 13 is provided to cover the cathode 12. Meanwhile, a second flexible substrate C provided with a fourth barrier layer 14 is prepared on the flexible supporting member 23. When a face of the fourth barrier layer 14 of the second flexible substrate C and a face of the third barrier layer 13 are made to face each other, a second thermosetting resin layer 22 is interposed there-between, these are laminated with each other, and heating is carried out by a heat press or the like, the thermosetting resin layer 22 also functions as an adhering agent to form an integrated lamination structure.

### EXAMPLES

Although the invention will be explained further specifically by examples as follows, the invention is not limited by the examples described below.

### Example 1

### 1. Fabrication of Thermosetting Resin Layer

A resin composition having a composition described below is coated on a
polyester film (hereinafter, sometimes described as a PET film) having a thickness of
100 μm as a temporary support. A thickness of a coating after drying is 20 μm.

| | | |
|---|---|---|
| polyvinylbutyral resin (product name: ESLEC BLS, made by Sekisui Kagaku | 12 | g |
| (Corporation)) | | |
| acrylic resin (product name: DIANAL BR87, made by Mitsubishi Rayon | 48 | g |
| (Corporation)) | | |
| urethane acrynate (product name: U6HA, made by Shinnakamura Kagaku | 16 | g |
| (Corporation)) | | |
| pentaerythritoldiacrylate | 24 | g |
| azoisobutylnitril | 0.3 | g |
| methylethylketone | 400 | ml |

### 2. Fabrication of Flexible Substrate

A SiON film is formed as a barrier layer on a polyethylene naphthalate film (hereinafter, sometimes described as a PEN film) having a thickness of 100 μm as a flexible supporting member, with a thickness of 1 μm by using a CVD film manufacturing apparatus made by ULVAC, Inc. Successively, the PET film is peeled off and removed from the thermosetting resin film manufactured as described above, only the resin layer is laminated on the barrier layer, the resin layer is adhered to the barrier layer by carrying out heat pressing from above the resin layer, and a surface of the resin layer is flattened. Heat press conditions are a temperature of 100° C., a press pressure of 0.2 MPa, and a time of 1 hour.

The obtained flexible substrate is excellent in smoothness of the surface, tenacious against deformation such as bending to bend or the like, and does not exhibit exfoliation or generation of cracks during handling.

### Example 2

### 1. Fabrication of Organic Electroluminescence Element

### <Forming Second Barrier Layer>

A second barrier layer described below is provided above the resin layer of the flexible substrate manufactured in Example 1.

A SiON film is provided with a thickness of 1 μm at a film forming rate of 20 nm/minute by using the CVD film forming apparatus made by ULVAC Inc.

### <Forming Luminescent Laminate>

A flexible substrate provided with the second barrier layer is introduced into a vacuum chamber, and an ITO thin film (thickness: 100 nm) is formed on the substrate as a transparent electrode by a DC magnetron sputterer (conditions: base material temperature of 100° C., oxygen pressure of 1×10⁻³ Pa) by using an ITO target (indium: tin=95:5 (in molar ratio) having a SnO₂ content of 10% by weight above the second barrier layer. A surface resistance of the ITO thin film is 40 Ω/□. Next, the assembly is put into a cleaning vessel and cleaned with pure water, and the assembly is subjected to UV-ozone treatment for 30 minutes.

Organic EL functional layers described below are successively provided thereon.

Hole injecting layer: 2-TNATA is vapor-deposited at a rate of 1 nm/second by a vacuum vapor deposition method so as to be provided with a thickness of 140 nm.

Hole transporting layer: As a hole transporting material, N,N′-dinaphthyl-N,N′-diphenyl benzidine (NPD) is vapor-deposited by a vacuum vapor deposition method so as to be provided with a thickness of 30 nm.

Luminescent layer: Luminescent material Alq is provided with a thickness of 20 nm by a vacuum vapor deposition method.

Electron injecting layer: LiF is vapor-deposited so as to be provided with a thickness of 0.5 nm.

Further, a patterned mask (a mask constituting a luminescent area of 2 mm×2 mm) is installed above the electron injecting layer, and 100 nm of aluminum is vapor-deposited inside of a vapor deposition apparatus to form a cathode.

Aluminum lead wires are respectively wired from the transparent electrode (which functions as an anode) and a cathode to form the organic EL luminescence laminate.

### <Forming Third Barrier Layer>

A third barrier layer described below is provided above the cathode.

A SiON film is provided with a thickness of 1 μm at a film forming rate of 20 nm/minute by using the CVD film forming apparatus made by ULVAC Inc.

### <Manufacturing of Second Flexible Substrate>

A SiON film is similarly provided with a thickness of 1 μm as a fourth barrier layer on PEN having a thickness of 100 μm as a second flexible supporting member.

### <Manufacturing of Organic EL Luminescence Device>

A face of the third barrier layer of the organic EL luminescence laminate and a face of the fourth barrier layer of the second flexible substrate are made to face each other, a resin layer obtained by peeling off the PET film from the thermosetting resin film manufactured in Example 1 is interposed therebetween, and heat pressing is carried out from above the obtained laminate to form a laminate in which the resin layer served as an adhering layer. Heat press conditions are a temperature of 100° C., a press pressure of 0.2 MPa, and a time of 1 hour.

### <Effects>

The obtained organic EL luminescence device has a configuration that is substantially symmetrical in an up and down direction with the organic EL luminescence element, at the center, and the organic EL luminescence element is disposed substantially at a neutral face of the organic EL luminescence device, and therefore, stress relaxation is effectively exerted with respect to physical deformation, and defects such as cracks, exfoliation and the like are prevented from occurring at the barrier layer and the organic EL functional layers.

As described above, the invention is applicable to a supporting substrate, a barrier layer (sealing substrate) or the like in various electronic devices such as an organic EL luminescence element constituting an organic electroluminescence element as well as an electroluminescence element such as an inorganic electroluminescence element or the like, a semiconductor element, a liquid crystal element and the like.

<<Description in Drawings>>

A: flexible substrate, B: organic EL laminate, C: second flexible substrate, 1: temporary support, 2: thermo-setting resin layer, 3: flexible supporting member, 4: first barrier layer, 5: second barrier layer, 6: transparent anode (ITO), 7: hole injection layer, 8: hole transporting layer, 9: luminescent layer, 10: electron transporting layer, 11: electron injection layer, 12: cathode, 13: third barrier layer, 22: second thermo-setting resin layer, 14: fourth barrier layer, 23: flexible supporting member

What is claimed is:

1. A method of manufacturing a flexible substrate for an electronic device comprising at least a barrier layer and a flattened layer on a flexible supporting member, wherein the flattened layer comprises at least a thermosetting resin layer, the method comprising providing the barrier layer above the flexible supporting member, and providing the flattened layer by facing the thermosetting resin layer toward a face of the barrier layer and adhering the thermosetting resin layer and the barrier layer by heating.

2. The method of manufacturing a flexible substrate for an electronic device according to claim 1, wherein a process providing the flattened layer includes forming a flattened surface by facing the thermosetting resin layer toward the face of the barrier layer so as to overlap therewith and thereafter heating the thermosetting resin layer by a heat press.

3. A method of manufacturing a flexible electronic device comprising:
1) manufacturing a flexible substrate including providing a first barrier layer on a flexible supporting member, and providing a flattened layer by facing a thermosetting resin layer toward a face of the first barrier layer and adhering the thermosetting resin layer and the first barrier layer by heating;
2) providing a second barrier layer on a surface of the flattened layer of the flexible substrate; and
3) providing functional layers of an electronic device on a surface of the second barrier layer.

4. A method of manufacturing a flexible electronic device comprising:
1) manufacturing a first flexible substrate including providing a first barrier layer above a first flexible supporting member, and providing a flattened layer by facing a first thermosetting resin layer thereof toward a face of the first barrier layer and adhering the first thermosetting resin layer and the first barrier layer by heating;
2) providing a second barrier layer on a surface of the flattened layer of the first flexible substrate;
3) providing functional layers of an electronic device on a surface of the second barrier layer;
4) providing a third barrier layer to cover a surface of the functional layers; and
5) providing a protection film, which comprises a fourth barrier layer and a second thermosetting resin layer in order on a second flexible supporting member, by facing a face of the second thermosetting resin layer toward a face of the third barrier layer and adhering the second thermosetting resin layer and the third barrier layer by heating.

5. The method of manufacturing a flexible substrate for an electronic device according to claim 1, wherein the electronic device is an organic electroluminescence element, an inorganic electroluminescence element or a semiconductor element.

6. The method of manufacturing a flexible electronic device according to claim 3, wherein the electronic device is an organic electroluminescence element, an inorganic electroluminescence element or a semiconductor element.

7. The method of manufacturing a flexible electronic device according to claim 4, wherein the electronic device is an organic electroluminescence element, an inorganic electroluminescence element or semiconductor element.

8. A flexible substrate for an electronic device manufactured by the manufacturing method according to claim 1.

9. An electronic device manufactured by the manufacturing method according to claim 3.

10. An electronic device manufactured by the manufacturing method according to claim 4.
